(19) United States
(12) Patent Application Publication
(10) Pub. No.: US 2013/0265712 A1
(43) Pub. Date: Oct. 10, 2013

(54) SERVER HEAT DISSIPATING ASSEMBLY

(71) Applicant: YAO-TING CHANG, New Taipei (TW)

(72) Inventor: YAO-TING CHANG, New Taipei (TW)

(21) Appl. No.: 13/709,436

(22) Filed: Dec. 10, 2012

(30) Foreign Application Priority Data
Apr. 10, 2012 (TW) 101112555

(51) Int. Cl. G06F 1/20

(52) U.S. Cl. CPC G06F 1/20
USPC 361/679.47; 361/679.54

(57) ABSTRACT

A server heat dissipating assembly includes a server chassis, a heat dissipating unit, and at least one connecting unit. Several electronic components are mounted inside the server chassis, the server chassis defines a plurality of holes corresponding in location to each of the several electronic components. The heat dissipating unit includes several connecting ports and an exhaust fan. The connecting unit is connected to at least one hole of the server chassis and at least one connecting port of the heat dissipating unit, the exhaust fan exhausts the heat from the server chassis through the connecting unit.

### BACKGROUND

1. Technical Field

The present disclosure relates to servers for computer systems, and particularly to a server heat dissipating assembly.

2. Description of Related Art

Fans mounted inside a server dissipate the heat that is generated by the working components. However, with the miniaturization of the server, the space in the server chassis is very limited. Therefore, there is limit to the size and number of fans that can be installed inside the server. If there are not enough fans, the dissipation of heat may not be ensured. In addition, some electronic components with high power consumption can generate more heat than other components, therefore, the heat is more centralized within the server chassis. Therefore, a more efficient cooling method is needed.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a server heat dissipating assembly.

FIG. 2 is an exploded, isometric view of the server heat dissipating assembly shown in FIG. 1.

FIG. 3 is another exploded, isometric view of the heat dissipating unit shown in FIG. 2.

FIG. 4 is an assembled, isometric view of the server heat dissipating assembly mounted in a server cabinet.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one”.

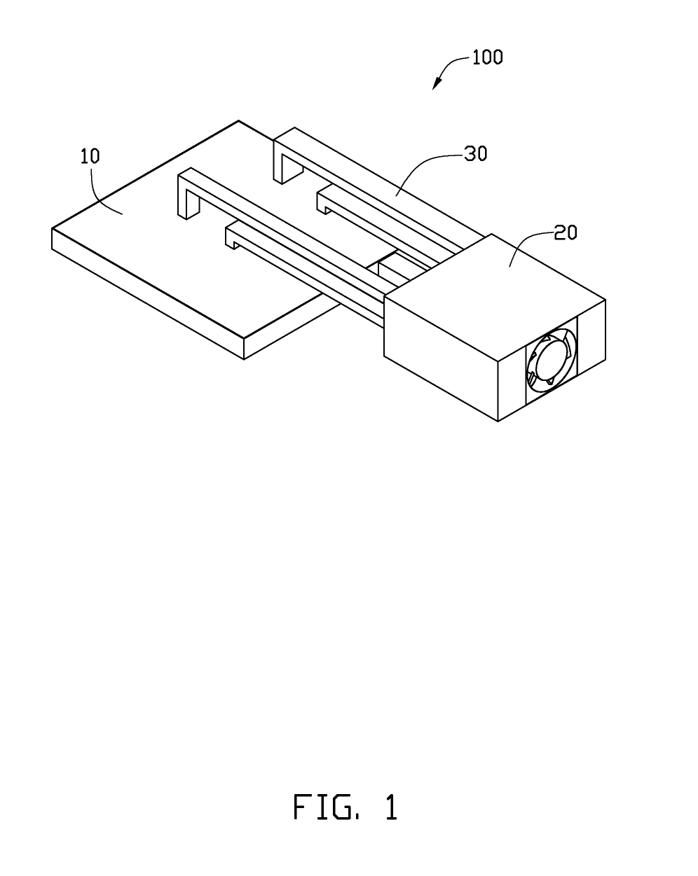

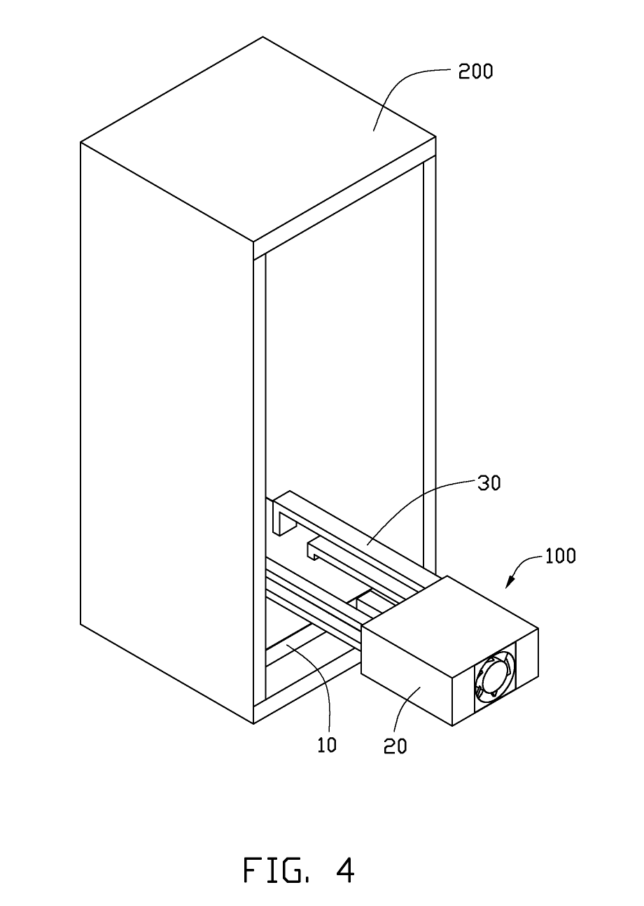

FIG. 1 is an exemplary embodiment of a server heat dissipating assembly 100. The server heat dissipating assembly 100 includes a server chassis 10, a heat dissipating unit 20, and at least one connecting unit 30. The server chassis 10 is mounted on a server cabinet 200 (shown in FIG. 4). In this embodiment, the connecting unit 30 is a pipe. The two ends of the connecting unit 30 are connected to the server chassis 10 and the heat dissipating unit 20 respectively. The connecting unit 30 is extended from inside of the server cabinet 200 to the outside of the server cabinet 200. The heat dissipating unit 20 is positioned outside the server cabinet 200 and is used to dissipate heat from the server chassis 10.

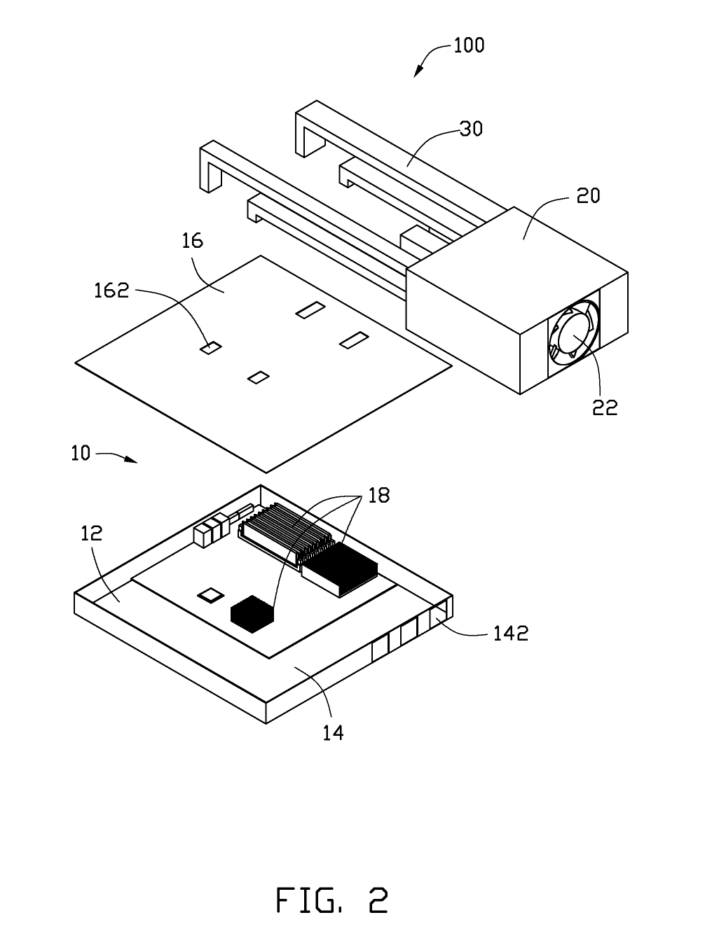

FIG. 2 is an embodiment of the server heat dissipating assembly 100. In the embodiment, the server chassis 10 is a hollow box. The server chassis 10 includes a front end 12, a back end 14, and a cover 16. The server chassis 10 receives several electronic components 18. In this embodiment, the several electronic components 18 have high power consumption. When the server is working, the several electronic components 18 generate heat, which is the main heat source of the server chassis 10. The server chassis 10 defines a plurality of holes on the different parts. The plurality of holes includes a plurality of first holes 142 defined in the back end 14, and a plurality of second holes 162 defined in the cover 16. The plurality of second holes 162 correspond in location to each of the several electronic components 18, and are beneficial for dissipating heat from the several electronic components 18. The first holes 142 and the second holes 162 can be the ports for the pipe, and used to be connected to the connecting unit 30.

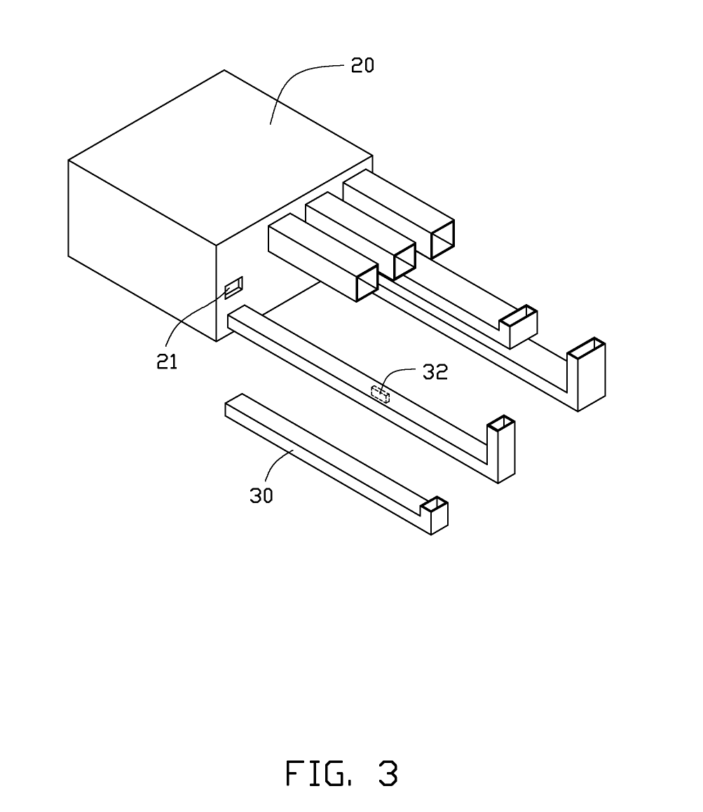

FIG. 3 is another view of the heat dissipating unit 20 shown in FIG. 2. The heat dissipating unit 20 includes several connecting ports 21 and an exhaust fan 22. The several connecting ports 21 and the exhaust fan 22 are defined at the opposite ends of the heat dissipating unit 20. The several connecting ports 21 can be the ports for the pipe, and used to connect the connecting unit 30. The exhaust fan 22 is used for generating airflow from the connecting ports 21 to the exhaust fan 22, which is exhausted to the outside by the exhaust fan 22. Furthermore, the exhaust fan 22 can includes a control unit (not shown), which can regulate the speed of the extractive airflow according to the heat condition inside the server chassis 10.

The server chassis 10 and the heat dissipating unit 20 are connected by at least one connecting unit 30. One end of the connecting unit 30 can be connected to the first hole 142 or the second hole 162. The hole connected to the connecting unit 30 can be an exhaust port. The other holes can be air admission ports. The other end of the connecting unit 30 can be connected to one of the connecting ports 21 of the heat dissipating unit 20. The number of the connecting unit 30 and the holes 142, 162 are selected according to the heat condition inside the server chassis 10. For example, when the temperature inside the server chassis 10 does not get very high, a small number of connecting units 30 can be connected to the first holes 142 or the second holes 162. For example, one or two connecting unit 30 may be connected to the server chassis 10, then the connecting unit 30 is connected to the second hole 162 corresponding to the electronic components 18 with highest temperature. When the temperature inside the server chassis 10 gets very high, a larger number of connecting units 30 can be connected to the first holes 142 and the second holes 162. Only one hole remains as an air admission port of the server chassis 10, then the connecting units 30 are connected to all the second holes 162 to make sure of efficient the heat dissipating for the electronic components 18.

In addition, the connecting unit 30 includes an airflow alarm 32. The airflow alarm 32 can set a critical value for the alarm, when the speed of airflow through the connecting unit 30 is greater than the preset critical value, the airflow alarm 32 will sound to warn the operator an error is occurred in the server heat dissipating assembly 100.

In this embodiment, a plurality of connecting units 30 are connected to the plurality of second holes 162 and the plurality of first holes 142. The holes connected to the connecting unit 30 are used as exhaust ports of the server chassis 10, while leaving at least one hole as the air admission port of the server chassis 10. The connecting units 30 are connected to the heat dissipating unit 20 along with the exhaust fan 22. The exhaust fan 22 exhausts the heat inside the server chassis 10 through the connecting unit 30 cooling the electronic components 18 while working. Moreover, because the plurality of second holes 162 are located adjacent the electronic components 18, the heat generated by the electronic components 18 can be dissipated immediately, directly, and rapidly. This makes sure the temperature inside the server chassis 10 does not get too high, and provides a suitable environment for the electronic components 18 to work normally.

Additionally, when a small number of connecting unit 30 are connected to the server chassis 10 and the heat dissipating unit 20, the airflow alarm 32 of the connecting unit 30 sets critical value for the alarm. The exhaust fan 22 regulates the speed of the extractive airflow according to the heat condition inside the server chassis 10. When the temperature is high inside the server chassis 10, the exhaust fan 22 generates stronger extractive airflow to ensure heat dissipating. And when the extractive airflow is greater than the preset critical value of the alarm, the airflow alarm 32 sounds to warn the operator to increase the number of connecting units 30 connected to the server chassis 10 and the heat dissipating unit 20, the ensure the heat can be dissipated immediately, rapidly and effectively.

Because one end of the heat dissipating unit 20 defines several connecting ports 21, the heat dissipating unit 20 can be connected to several connecting units 30 at the same time. When a server chassis 10 is connected to a small number of connecting units 30, the heat dissipating unit 20 can be connected to several server chassis 10 at the same time, and dissipate heat for the several server chassis 10 at the same time. Therefore, each server chassis 10 can save the space for mounting fans respectively, which is benefit to the miniaturization of the server chassis 10.

FIG. 4 is an assembled, isometric view of the server heat dissipating assembly 100 mounted in a server cabinet 200. The heat dissipating unit 20 is located outside the server cabinet 200, and extended into the server cabinet 200 through the connecting unit 30. Furthermore, the heat dissipating unit 20 can be placed outdoors by lengthening the connecting units 30. Therefore, it can reduce indoor noise, and avoid the rising of temperature caused by the exhausted heat from the exhaust fan 22.

Even though numerous characteristics and advantages of the embodiments have been set forth in the foregoing description, together with details of the structure and function of the embodiments, the present disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A server heat dissipating assembly, comprising:
a server chassis, wherein several electronic components are mounted inside the server chassis, the server chassis defines a plurality of holes corresponding in location to each of the several electronic components;
a heat dissipating unit, including several connecting ports and an exhaust fan; and
at least one connecting unit, wherein the connecting unit is connected to at least one hole of the server chassis and at least one connecting port of the heat dissipating unit, the exhaust fan exhausts the heat from the server chassis through the connecting unit.

2. The server heat dissipating assembly of claim 1, wherein the connecting unit is a pipe.

3. The server heat dissipating assembly of claim 2, wherein the server chassis includes a cover, the holes is defined in the cover and one end of the server chassis, the holes includes a plurality of first holes defined in one end of the server chassis and a plurality of second holes defined in the cover, the holes are the ports for the pipe.

4. The server heat dissipating assembly of claim 2, wherein the connecting ports of the heat dissipating unit are the ports for the pipe.

5. The server heat dissipating assembly of claim 1, further comprising several server chassis, wherein the several server chassis are connected to the several connecting ports of the heat dissipating unit through a plurality of connecting units.

6. The server heat dissipating assembly of claim 1, wherein the exhaust fan generates extractive airflow and regulates the speed of extractive airflow according to the heat condition inside the server chassis.

7. The server heat dissipating assembly of claim 1, wherein the connecting unit includes an airflow alarm, the airflow alarm set an alarm critical value, when the speed of airflow through the connecting unit is greater than the alarm critical value, the airflow alarm alarms.

8. The server heat dissipating assembly of claim 1, wherein the plurality of server chassis are mounted in a server cabinet, the heat dissipating unit is located outside the server cabinet, the connecting unit is extended from inside the server cabinet to the outside the server cabinet.

9. A server chassis for a server heat dissipating assembly, the server heat dissipating assembly including a heat dissipating unit and at least one connecting unit, the server chassis is a hollow box comprising:
a back end;
a cover; and
a plurality of electronic components mounted within the server chassis;
wherein a plurality of holes are defined in the back end and the cover, the holes defined in the cover are correspond in location to each of the plurality of electronic components, at least one hole is connected to the connecting unit, the connecting unit is also connected to the heat dissipating unit, the heat dissipating unit exhausts the heat from the server chassis through the connecting unit.

10. The server chassis of claim 9, wherein the heat dissipating unit includes several connecting ports and an exhaust fan, the connecting ports are connected to the connecting unit, the exhaust fan exhausts the heat from the server chassis through the connecting unit.

11. The server chassis of claim 10, wherein the connecting unit is a pipe.

12. The server chassis of claim 11, wherein the connecting ports of the heat dissipating unit and the hole of the server chassis are the ports for the pipe.

13. The server chassis of claim 10, wherein the exhaust fan generates extractive airflow and regulates the speed of extractive airflow according to the heat condition inside the server chassis.

14. The server chassis of claim 9, wherein the quantity of the server chassis is greater than one, the quantity of sever chassis are connected to the plurality of connecting ports of the heat dissipating unit through a plurality of connecting units.

15. The server chassis of claim 9, wherein the connecting unit includes an airflow alarm, the airflow alarm set an alarm critical value, when the speed of airflow through the connecting unit is greater than the alarm critical value, the airflow alarm alarms.

16. The server chassis of claim 9, wherein the server chassis is mounted in a server cabinet, the heat dissipating unit is located outside the server cabinet, the connecting unit is extended from inside the server cabinet to the outside the server cabinet.
